(19) United States
(12) Patent Application Publication
(10) Pub. No.: US 2024/0223807 A1
(43) Pub. Date: Jul. 4, 2024

(54) METHOD, APPARATUS, AND MEDIUM FOR POINT CLOUD CODING

(71) Applicants: Beijing Bytedance Network Technology Co., Ltd., Beijing (CN); Bytedance Inc., Los Angeles, CA (US)

(72) Inventors: Yingzhan XU, Beijing (CN); Kai ZHANG, Los Angeles, CA (US); Li ZHANG, Los Angeles, CA (US)

(21) Appl. No.: 18/603,149

(22) Filed: Mar. 12, 2024

Related U.S. Application Data
(63) Continuation of application No. PCT/CN2022/118242, filed on Sep. 9, 2022.

(30) Foreign Application Priority Data
Sep. 13, 2021 (WO) PCT/CN2021/118011

(51) Int. Cl. H04N 19/597; H04N 19/70

(52) U.S. Cl. CPC H04N 19/597; H04N 19/70

(57) ABSTRACT

Embodiments of the present disclosure provide a method for point cloud coding. The method comprises: determining, during a conversion between a point cloud sequence and a bitstream of the point cloud sequence, an information unit for a current sample of the point cloud sequence and at least one parameter value, the information unit being obtained by coding the current sample with the at least one parameter value, the at least one parameter value being absent from the information unit; and performing the conversion based on the information unit and the at least one parameter value. Compared with the conventional solution, the proposed method can advantageously improve coding efficiency.

### CROSS REFERENCE

This application is a continuation of International Application No. PCT/CN2022/118242, filed on Sep. 9, 2022, which claims the benefit of International Application No. PCT/CN2021/118011 filed on Sep. 13, 2021. The entire contents of these applications are hereby incorporated by reference in their entireties.

### FIELD

Embodiments of the present disclosure relates generally to video coding techniques, and more particularly, to coding and encapsulation of coding parameters in point cloud coding.

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding efficiency of conventional point cloud coding techniques is generally expected to be further improved.

### SUMMARY

Embodiments of the present disclosure provide a solution for point cloud coding.

In a first aspect, a method for point cloud coding is proposed. The method comprises: determining, during a conversion between a point cloud sequence and a bitstream of the point cloud sequence, an information unit for a current sample of the point cloud sequence and at least one parameter value, the information unit being obtained by coding the current sample with the at least one parameter value, the at least one parameter value being absent from the information unit; and performing the conversion based on the information unit and the at least one parameter value.

According to the method in accordance with the first aspect of the present disclosure, the at least one parameter value for coding a sample of the point cloud sequence is not included in the corresponding information unit of the sample, which makes it possible to group parameter values together for a plurality of samples so as to avoid redundancy of parameter values to be transmitted. Compared with a conventional solution where parameter values are transmitted for each of samples of the point cloud sequence, the proposed method can advantageously reduce the coding bits while maintaining the coding quality, and the coding efficiency may be improved.

In a second aspect, an apparatus for processing point cloud data is proposed. The apparatus for processing point cloud data comprising a processor and a non-transitory memory with instructions thereon. The instructions upon execution by the processor cause the processor to perform a method in accordance with the first aspect of the present disclosure.

In a third aspect, a non-transitory computer-readable storage medium is proposed. The non-transitory computer-readable storage medium storing instructions that cause a processor to perform a method in accordance with the first aspect of the present disclosure.

In a fourth aspect, another non-transitory computer-readable recording medium is proposed. The non-transitory computer-readable recording medium stores a bitstream of a point cloud sequence which is generated by a method performed by a point cloud processing apparatus. The method comprises: determining an information unit for a current sample of the point cloud sequence and at least one parameter value, the information unit being obtained by coding the current sample with the at least one parameter value, the at least one parameter value being absent from the information unit; and generating the bitstream based on the information unit and the at least one parameter value.

In a fifth aspect, a method for storing a bitstream of a point cloud sequence is proposed. The method comprises: determining an information unit for a current sample of the point cloud sequence and at least one parameter value, the information unit being obtained by coding the current sample with the at least one parameter value, the at least one parameter value being absent from the information unit; generating the bitstream based on the information unit and the at least one parameter value; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 is a block diagram that illustrates an example point cloud coding system that may utilize the techniques of the present disclosure;

FIG. 2 illustrates a block diagram that illustrates an example point cloud encoder, in accordance with some embodiments of the present disclosure;

FIG. 3 illustrates a block diagram that illustrates an example point cloud decoder, in accordance with some embodiments of the present disclosure;

FIG. 4 is a schematic diagram illustrating a sample structure when a coded G-PCC bitstream is stored in a single track;

FIG. 5 is a schematic diagram illustrating a multi-track container of G-PCC bitstream;

FIG. 6 is a schematic diagram illustrating an example of a G-PCC bitstream in a single track by signaling SLP in TLVs before sample information;

FIG. 7 is a schematic diagram illustrating an example of a G-PCC bitstream in a single track by signaling SLP in sequence configuration box before sample information;

FIG. 8 is a schematic diagram illustrating an example of a G-PCC bitstream in a single track by using group level structure;

FIG. 9 illustrates a flowchart of a method for point cloud coding in accordance with some embodiments of the present disclosure; and

FIG. 10 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

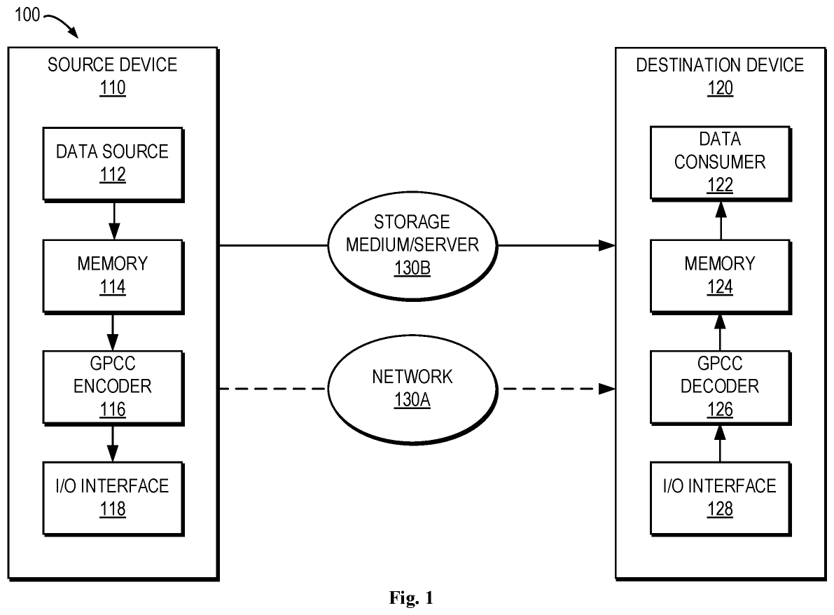

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data. For example, data source 112 may generate the point cloud data, or produce a combination of live point cloud data, archived point cloud data, and computer-generated point cloud data. In each case, GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like. In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

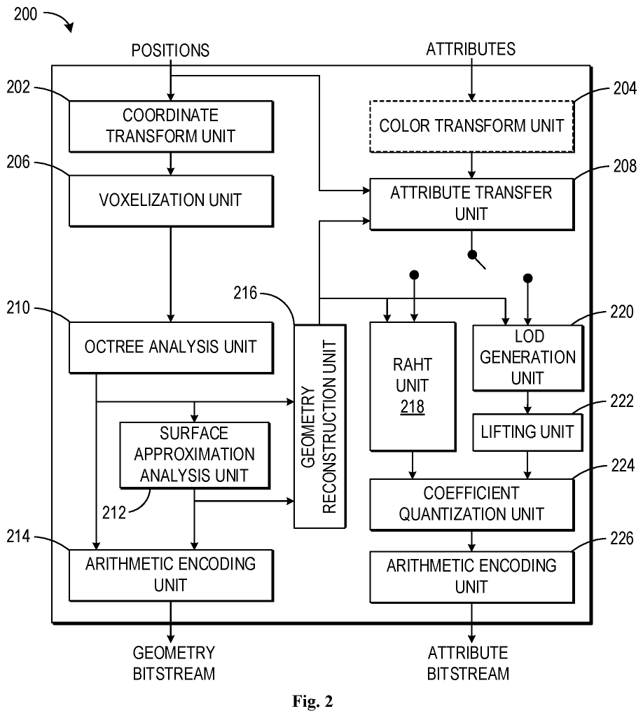

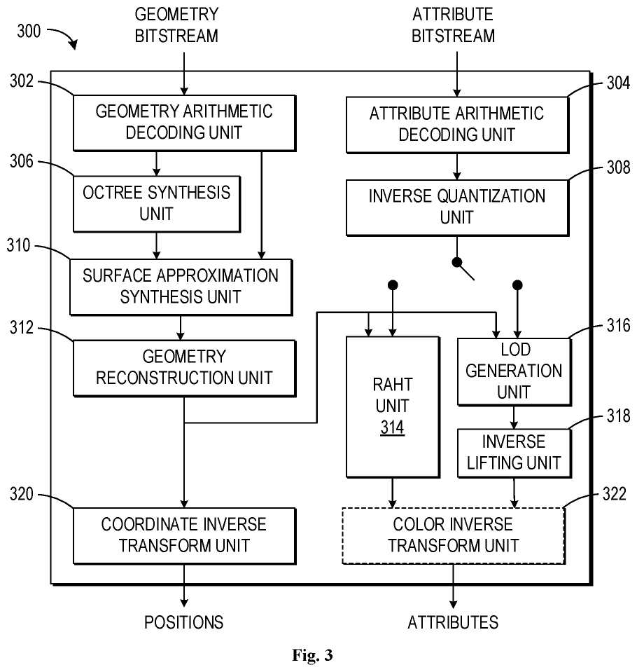

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream.

Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. Summary

This disclosure is related to point cloud coding technologies. Specifically, it is about coding and encapsulation of coding parameters in point cloud coding. The ideas may be applied individually or in various combination, to any point cloud coding standard or non-standard point cloud codec, e.g., the being-developed Geometry based Point Cloud Compression (G-PCC).

### 2. Abbreviations

G-PCC Geometry based Point Cloud Compression
MPEG Moving Picture Experts Group
3DG 3D Graphics Coding Group
CFP Call For Proposal
V-PCC Video-based Point Cloud Compression
SPS Sequence Parameter Set
GPS Geometry Parameter Set
APS Attribute Parameter Set
TLV Type-length-value bytestream format
GSH Geometry Data Unit Header
ASH Attribute Data Unit Header
GOF Group Of Frames
SLP Sequence Level Parameters
GLP GOF Level Parameters
FLP Frame Level Parameters
ISOBMFF ISO Base Media File Format

### 3. Background

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC) is appropriate for point sets with a relatively uniform distribution of points. Geometry-based Point Cloud Compression (G-PCC) is appropriate for more sparse distributions. Both V-PCC and G-PCC support the coding and decoding for single point cloud and point cloud sequence.

In one point cloud sequence, there are one or multiple point cloud frames. The point cloud sequence can be divided into one or multiple group of frames (GOF). Usually, the number of point cloud frames in each GOF is the same, indicated as the GOF size.

In one point cloud frame, there are many data points to describe the 3D objects or scenes. For each data point, there may be corresponding geometry information and attribute information. Geometry information is used to record the spatial location of the data point. Attribute information is used to record more details of the data point, such as texture, normal vector and reflection. Usually there are many optional tools in the codec to support the coding and decoding of geometry information and attribute information respectively.

### 3.1 Coding Parameters

There are some coding parameters in the encoder to control the encoding process. Some of them are signaled to the decoder to support the decoding process. The signaled parameters may be classified into multiple levels according to their roles in the decoding process, such as sequence level parameters (SLP) and frame level parameters (FLP).

SLP are the parameters that can be applied to the decoding process of all frames in the point cloud sequence. There may be one or multiple groups of SLP for one point cloud sequence. For each point cloud frame, one group of SLP can be applied. Furtherly, the SLP can be classified and stored in several clusters, such as geometry parameter set (GPS), attribute parameter set (APS) and sequence parameter set (SPS). The parameters that control the geometry coding tools are stored in GPS. The parameters that control the attribute coding tools are stored in APS. The other SLP, which describe the features of the point cloud sequence or control the total coding process, can be stored in SPS. For example, the parameters that describe the attribute category of point cloud sequence and the data accuracy of coding process are stored in SPS.

FLP are the parameters that can only be applied to the decoding process of one point cloud frame. The FLP between point cloud frames are usually different. For example, the parameters that describe the point number and global motion vector of one point cloud frame are signaled as FLP.

### 3.2 Bitstream Encapsulation Structure

In G-PCC, the output of the encoder is one bitstream that stores the coded geometry data, attribute data, mate data and coding parameters. One type-length-value (TLV) encapsulation structure is the unit of G-PCC bitstream. Each TLV contains one of SPS, GPS, APS, tile inventory, frame boundary marker, geometry data unit, and attribute data unit. The coded G-PCC bitstream is encapsulated as one or more tracks in ISOBMFF file.

SLP are stored in parameter set TLVs which contain one of SPS, GPS and APS.

Geometry data and FLP for geometry coding are stored in geometry TLVs which contain geometry data unit. Geometry data unit header (GSH) is the encapsulation structure at the start location of the bitstream for each geometry TLV. The FLP for geometry coding are stored in the GSH.

Attribute data and FLP for attribute coding are stored in attribute TLVs which contain attribute data unit. Attribute data unit header (ASH) is the encapsulation structure at the start location of the bitstream for each attribute TLV. The FLP for attribute coding are stored in the ASH.

### 3.3 Single Track Encapsulation of G-PCC Data in ISOBMFF

When the G-PCC bitstream is carried in a single track, the simple ISOBMFF encapsulation is utilized by storing the G-PCC bitstream in a single track without further processing. Each sample is composed of one or more G-PCC units.

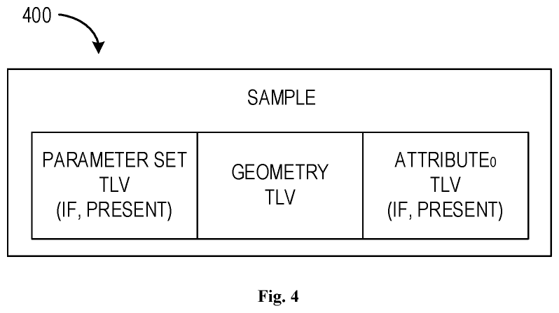

FIG. 4 depicts an example of the sample structure when the G-PCC geometry and attribute bitstream are stored in a single track. In this case, each sample contains at least one G-PCC unit containing geometry data unit, zero or more G-PCC units containing attribute data unit, and zero or more G-PCC units carrying parameter sets.

G-PCC tracks shall use GPCCSampleEntry with a sample entry type of ‘gpe1’ or ‘gpeg’.

Under the ‘gpe1’ sample entry, all SPS, GPS, APS, and tile inventory parameter sets shall be in the setupUnit array. Under the ‘gpeg’ sample entry, the parameter sets may be present in this array, or in the stream.

### 3.4 Multi-Track Encapsulation of G-PCC Data in ISOBMFF

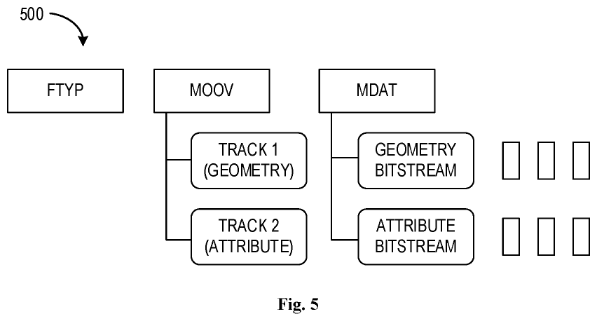

When the G-PCC bitstream is carried in multiple tracks per G-PCC component, each G-PCC component bitstream is mapped to an individual track. There are two types of G-PCC component tracks: G-PCC geometry track and G-PCC attribute track. Each sample in a track contains at least one G-PCC unit carrying a single G-PCC component data unit, not both of geometry and attribute data unit or multiplexing of different attribute data units. A G-PCC attribute track shall not multiplex different attribute sub-stream, e.g., color, reflectance. The general layout of a multi-track ISOBMFF G-PCC container is shown in FIG. 5.

Tracks belonging to the same G-PCC sequence are time-aligned. Samples that contribute to the same point cloud frame across different tracks shall have the same presentation time. When any parameter sets or tile inventory are present in samples, the decoding time of the parameter sets or tile inventory used for such samples shall be equal or prior to the decoding time of samples of corresponding G-PCC component data units. When all parameter sets are present in samples across multiple tracks, the decoding time of samples containing the SPS shall be equal or prior to the decoding time of samples containing the GPS, APS, or tile inventory. In addition, all tracks belonging to the same G-PCC sequence shall have the same implied or explicit edit lists.

G-PCC geometry track or G-PCC attribute track shall use GPCCSampleEntry with a sample entry type of ‘gpc1’ or ‘gpcg’.

Under the ‘gpc1’ sample entry, the setupUnit array of G-PCC geometry track shall contain all SPS, GPS, and tile inventory. The setupUnit array of G-PCC attribute track shall contain all associated APS and shall not contain any of SPS, GPS, and tile inventory.

Under the ‘gpcg’ sample entry, SPS, GPS, or tile inventory may be present in the setupUnit array of the sample entry or in the stream of G-PCC geometry track. The APS may be present in the setupUnit array of the sample entry or in the stream of G-PCC attribute track. Any of SPS, GPS, and tile inventory shall not be present in G-PCC attribute tracks.

### 4. Problems

The existing designs for coding and encapsulation of coding parameters in point cloud compression have the following problems:
1. In current G-PCC, the SLP is coded and encapsulated repeatedly for each point cloud frame or sample in one point cloud sequence. However, for all point cloud frames in one point cloud sequence, the used groups of SLP may be unchanged across frames. Therefore, there are some unnecessary bits used to record the repeated SLP information in G-PCC bitstream.
2. In current G-PCC, there is no design for the coding of the GOF level parameters (GLP). Some coding parameters are unchanged for all point cloud frames in one GOF, such as the real GOF size, which can be GLP. These coding parameters are processed as FLP, which are coded repeatedly for each point cloud frame in one GOF. Therefore, there will be some unnecessary bits used to record the repeated SLP information in the output of point cloud encoder.
3. In current G-PCC, there is no design for the encapsulation of the GLP. The coding parameters set bitstream which are used to record the GLP information are encapsulated repeatedly in more than one boxes. However, the GLP bitstreams are usually the same for all points in one GOF. Therefore, there will be some unnecessary structures used to store the repeated information in G-PCC bitstream.

### 5. Exemplary Embodiments

To solve the above problems and some other problems not mentioned, methods as summarized below are disclosed. The embodiments should be considered as examples to explain the general concepts and should not be interpreted in a narrow way. Furthermore, these embodiments can be applied individually or combined in any manner.

In the following discussion, SLP may include but not limited to the coding parameters in certain exiting syntax elements, such as SPS/GPS/APS.

1) It is proposed to group and signal the SLP information together in one or multiple TLVs.
a) In one example, SLP information may be signalled before or after sample information.
b) In one example, one or multiple sets of SLP information may be signalled at a first level structure, such as SPS TLV/GPS TLV/APS TLV.
c) Alternatively, furthermore, indication of how many sets of SLP information may be signalled in the bitstream.
d) In one example, the SLP information may be signalled before a second level structure (e.g., frame/picture/slice/tile/subpicture).
e) Furthermore, at the second level structure, at least one indication referring to at least one set of SLP information may be further signalled.
   (1) The indication may be conditionally signalled, e.g., depending on whether there is more than one set of SLP information at the first level.
   (2) The indication may be represented by some indices (e.g., SLP_SPS_id/SLP_GPS_id/SLP_APS_id) which indicate the associated sets of SLP information to be applied for processing the current second level (e.g., current point cloud frame).
   (3) The indication may be coded with fixed-length coding, unary coding, truncated unary coding, etc. al.
   (4) The indication may be coded in a predictive way.
   (5) In one example, the indication may be signalled in GSH/ASH.
   (6) Alternatively, the indication may be signalled in the configuration box in the sample entry.
      2) Instead of signalling the SLP information in the parameter TLVs per frame, it is proposed to group and signal the SLP information together in one sequence configuration box before all sample information. A “sequence configuration box” may refer to a syntax structure containing at least one sequence level syntax element.
a) In one example, one or multiple sets of SLP information may be signalled in one sequence configuration box at a first level.
b) Alternatively, furthermore, indication of how many sets of SLP information may be signalled in the box header.
c) In one example, the SLP information may be signalled before a second level (e.g., frame/picture/slice/tile/subpicture).
   i. Furthermore, at a second level, at least one indication referring to at least one set of SLP information may be further signalled.
      (1) The indication may be conditionally signalled, e.g., depending on whether there is more than one set of SLP information at the first level.
      (2) The indication may be represented by some indices (e.g., SLP_sequence_parameters_id/SLP_geometry_parameters_id/SLP_attribute_paramteters_id) which indicate the associated set of SLP information to be applied for processing the current second level (e.g., current picture).
      (3) The indication may be coded with fixed-length coding, unary coding, truncated unary coding, etc. al.
      (4) The indication may be predictively coded.
      (5) In one example, the indication may be signalled in certain exiting syntax elements, e.g., SPS/GPS/APS.
         3) It is proposed to signal the SLP information for the first sample of a sequences or when the SLP information of current sample is different from the that of the previous decoded sample, which may be in the same or different frames.
a) In one example, one or multiple sets of SLP information may be signalled in one point cloud sequence.
b) In one example, at a second level (e.g., frame/picture/slice/tile/subpicture), at least one indication may be signaled to indicate whether the SLP information of current sample is different from the that of the previous decoded sample.
   i. Alternatively, it may be derived implicitly whether the SLP information of current sample is different from the that of the previous decoded sample.
   ii. The indication may be conditionally signalled, e.g., depending on whether there is more than one set of SLP information at the first level.
   iii. The indication may be represented be some indices (e.g., SPS_unchanged_flag/GPS_unchanged_flag/APS_unchanged_flag) which indicate whether the SLP information of current sample is different from the that of the previous decoded sample.
   iv. The indication may be coded with fixed-length coding, unary coding, truncated unary coding, etc. al.
   v. The indication may be predictively coded.
   vi. In one example, the indication may be signalled in certain exiting syntax elements, e.g., SPS/GPS/APS.
c) In one example, the SLP information may be signalled in one or multiple TLVs (e.g., SPS TLV/GPS TLV/APS TLV) in the sample entry if the SLP information is different from that of the previous decoded sample.
d) In one example, the SLP information of the previous decoded sample may be inherited and applied by the current sample if the SLP information is not different from that of the previous sample.
   4) It is proposed to signal the SLP information for the first sample or when the SLP information of current sample is different from the that of all previous decoded samples, which may be in the same or different frames.
a) In one example, one or multiple sets of SLP information may be signalled in one point cloud sequence.
b) In one example, at a second level (e.g., frame/picture/slice/tile/subpicture), at least one indication may be signaled to indicate whether the SLP information of current sample is different from the that of all previous decoded samples.
   i. Alternatively, it may be derived implicitly whether the SLP information of current sample is different from the that of all previous decoded samples.
   ii. The indication may be conditionally signalled, e.g., depending on whether there is more than one set of SLP information at the first level.
   iii. The indication may be represented be some indices (e.g., SPS_new_flag/GPS_new_flag/APS_new_flag) which indicate whether the SLP information of current sample is different from the that of all previous decoded samples.
   iv. The indication may be coded with fixed-length coding, unary coding, truncated unary coding, etc. al.
   v. The indication may be predictively coded.
   vi. In one example, the indication may be signalled in certain exiting syntax elements, e.g., SPS/GPS/APS.
c) In one example, the SLP information may be signalled in one or multiple TLVs (e.g., SPS TLV/GPS TLV/APS TLV) in the sample entry if the SLP information is different from that of all previous decoded samples.
d) In one example, the SLP information of one of the previous decoded samples may be inherited and applied by the current sample if the SLP information is not different from that of this previous decoded sample.
e) Alternatively, furthermore, an indication of which sample that the SLP information is inherited from may be further signalled for the current sample.
   i. The indication may be conditionally signalled, e.g., depending on whether the SLP information is inherited from other samples.
   ii. The indication may be coded with fixed-length coding, unary coding, truncated unary coding, etc. al.
   iii. The indication may be predictively coded.
   iv. In one example, the indication may be signalled in certain exiting syntax elements, e.g., SPS/GPS/APS.
      5) It is proposed to group and signal the GLP information of a GOF together in one TLV before the sample information of a GOF.
a) In one example, one or multiple sets of GLP information may be signalled at GOF level.
b) In one example, each set of GLP information may be signaled in one GLP TLV for one GOF.
c) In one example, the GLP information of one GOF may be signalled before the sample (e.g., frame/picture/slice/tile/subpicture) information in the GOF.
d) In one example, the GLP information of one GOF may be applied to all samples in the GOF.

### 6. Embodiments

1) This embodiment describes an example of how to group and signal the SLP information together in one or multiple TLVs.

In the encoder, firstly, the encoder will group and encode the SLP information together before the geometry information and attribute information of all point cloud frames:
1. Encode each coding parameters in SPS in one SPS_TLV. For each SPS_TLV, there will be an SPS_id to indicate the parameter set.
2. Encode each coding parameters in GPS in one GPS_TLV. For each GPS_TLV, there will be an GPS_id to indicate the parameter set.
3. Encode each coding parameters in APS in one APS_TLV. For each APS_TLV, there will be an APS_id to indicate the parameter set.

Secondly, the FLP information will be encoded with the geometry information and attribute information for each point cloud frame. For each frame, there are three indices, SLP_SPS_id/SLP_GPS_id/SLP_APS_id, to indicate which set of SLP the current frame has applied.
1. Encode each index in GSH/ASH.
2. Encode FLP information in one GSH/ASH.

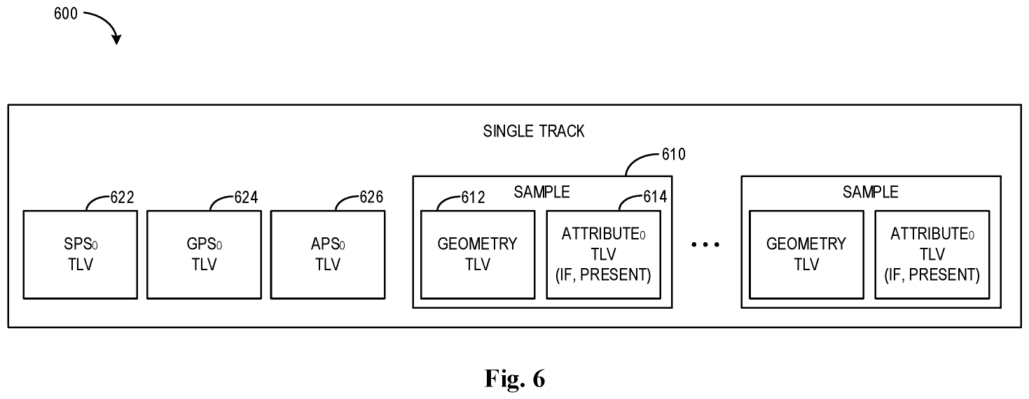

FIG. 6 depicts an example of the G-PCC bitstream which is stored in a single track. In this case, the SLP information is grouped and signalled in multiple TLVs before the sample entries.

In the decoder, firstly, the decoder will decode all the SLP information in SPS_TLV/GPS_TLV/APS_TLV.

Secondly, for each frame:
1. Decode SLP_SPS_id/SLP_GPS_id/SLP_APS_id in GSH/ASH.
2. Decode FLP information in one GSH/ASH.
3. Use SLP_SPS_id/SLP_GPS_id/SLP_APS_id to get the SLP information.
4. Use the SLP and FLP to decode the geometry information and attribute information.
   2) This embodiment describes an example of how to group and signal the SLP information together in one sequence configuration box before all sample information.

In the encoder, firstly, the encoder will group and encode the SLP information together before the geometry information and attribute information of all point cloud frames:
1. Encode each coding parameters in SPS and store the coded information in the sequence configuration box. For each set of SPS parameters, there will be an SPS_ID to indicate the parameter set.
2. Encode each coding parameters in GPS and store the coded information in the sequence configuration box. For each set of GPS parameters, there will be an GPS_ID to indicate the parameter set.
3. Encode each coding parameters in APS and store the coded information in the sequence configuration box. For each set of APS parameters, there will be an APS_ID to indicate the parameter set.

Secondly, For each frame, there are three indices, SLP_sequence_parameters_ID/SLP_geometry_parameters_ID/SLP_attribute_parameters_ID, to indicate which set of SLP the current frame has applied. The indices will be encoded and stored in SPS/GPS/APS, respectively.

Thirdly, the FLP information will be encoded in GSH/ASH with the geometry information and attribute information for each point cloud frame.

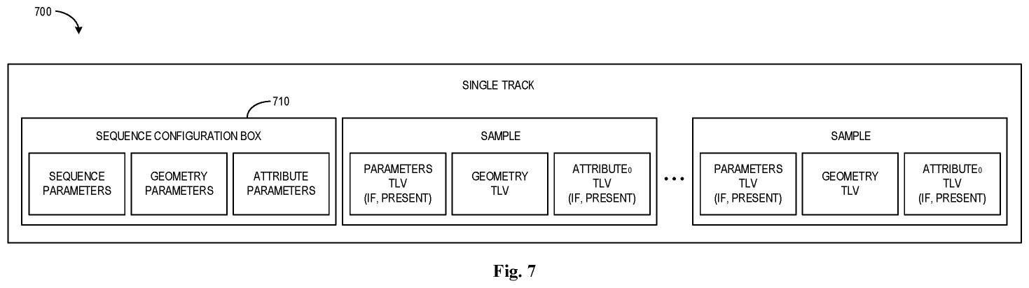

FIG. 7 depicts an example of the G-PCC bitstream which is stored in a single track. In this case, the SLP information is grouped and signalled in one sequence configuration box before the sample entries.

In the decoder, firstly, the decoder will decode all the SLP information in sequence configuration box.

Secondly, for each frame:
1. Decode SLP_sequence_parameters_ID/SLP_geometry_parameters_ID/SLP_attribute_parameters_ID in SPS/GPS/APS.
2. Decode FLP information in one GSH/ASH.
3. Use SLP_sequence_parameters_ID/SLP_geometry_parameters_ID/SLP_attribute_parameters_ID to get the SLP information.
4. Use the SLP and FLP to decode the geometry information and attribute information.
   3) This embodiment describes an example of how to signal the SLP information for the first sample of a sequences or when the SLP information of current sample is different from the that of the previous decoded sample.

In the encoder, firstly, the encoder will encode and store the SLP information in the SPS/GPS/APS for the first point cloud frame.

Secondly, for the other frames, the encoder will check whether the SLP information of the current frame is different from that of the previous encoded frame and encode three flags to indicate the check results. The flags will be encoded and stored in SPS/GPS/APS, respectively.
1. The flag SPS_unchange_flag is set to 1 if the SPS information of current frame is the same as that of the previous encoded frame. The flag SPS_unchange_flag is set to 0 if the SPS information of current frame is different from that of the previous encoded frame.
2. The flag GPS_unchange_flag is set to 1 if the GPS information of current frame is the same as that of the previous encoded frame. The flag GPS_unchange_flag is set to 0 if the GPS information of current frame is different from that of the previous encoded frame.
3. The flag APS_unchange_flag is set to 1 if the APS information of current frame is the same as that of the previous encoded frame. The flag APS_unchange_flag is set to 0 if the APS information of current frame is different from that of the previous encoded frame.

Thirdly, for the current frame, encode and store the SLP information in SPS/GPS/APS if the SLP information of current frame is different from that of the previous encoded frame.

The FLP information will be encoded in GSH/ASH with the geometry information and attribute information for each point cloud frame.

In this case, the bitstream structure can utilize the certain single track structure.

In the decoder, firstly, the decoder will decode the SLP information for the first frame.

Secondly, for the other frames:
1. Decode SPS_unchange_flag/GPS_unchange_flag/APS_unchange_flag in SPS/GPS/APS.
2. If the flags are set to 0, decode SLP information in one SPS/GPS/APS. Otherwise, inherit the SLP information from the previous decoded frame.
3. Decode FLP information from GSH/ASH.
4. Use the SLP and FLP to decode the geometry information and attribute information.
   4) This embodiment describes an example of how to signal the SLP information for the first sample or when the SLP information of current sample is different from the that of all previous decoded samples.

In the encoder, firstly, the encoder will encode and store the SLP information in the SPS/GPS/APS for the first point cloud frame. The SLP information and the frame_id will be recorded in one array SLP_array.

Secondly, for the other frames, the encoder will check whether the SLP information of the current frame is different from all SLP information in SLP_array and encode three flags to indicate the check results. The flags will be encoded and stored in SPS/GPS/APS, respectively.
1. The flag SPS_new_flag is set to 0 if the SPS information of current frame is the same as one of the SPS information in SLP_array. The flag SPS_new_flag is set to 1 if the SPS information of current frame is different from all SPS information in SLP_array.
2. The flag GPS_new_flag is set to 0 if the GPS information of current frame is the same as one of the GPS information in SLP_array. The flag GPS_new_flag is set to 1 if the GPS information of current frame is different from all GPS information in SLP_array.
3. The flag APS_new_flag is set to 0 if the APS information of current frame is the same as one of the APS information in SLP_array. The flag APS_new_flag is set to 1 if the APS information of current frame is different from all APS information in SLP_array.

Thirdly, for the current frame:
1. If the SLP information of current frame is different from that of all SLP information in SLP_array, encode and store the SLP information in SPS/GPS/APS and record the SLP information and frame_id of current frame in SLP_array.
2. If the SLP information of current frame is the same as that of any one of SLP information in SLP_array, encode and store the frame_id of the frame sharing the same SLP information with current frame in SPS/GPS/APS.

The FLP information will be encoded in GSH/ASH with the geometry information and attribute information for each point cloud frame.

In this case, the bitstream structure can utilize the certain single track structure.

In the decoder, firstly, the decoder will decode the SLP information for the first frame.

Secondly, for the other frames:
1. Decode SPS_new_flag/GPS_new_flag/APS_new_flag in SPS/GPS/APS.
2. If the flags are set to 1, decode SLP information in one SPS/GPS/APS. Otherwise, decode the frame _id and inherit the SLP information from corresponding decoded frame which is indicated by the frame_id.
3. Decode FLP information from GSH/ASH.
4. Use the SLP and FLP to decode the geometry information and attribute information.
   5) This embodiment describes an example of how to group and signal the GLP information of a GOF together in one TLV before the sample information of a GOF.

When the point cloud coded bitstream is carried in a single track, there may be one sequence configuration box in the track header to contain the SPS, GPS and APS.

There will be some samples in the single track. The samples can be divided into one or multiple sample groups. For each sample group, there may be one group configuration box to contain the GLP sets. Each sample is composed of one or more G-PCC units.

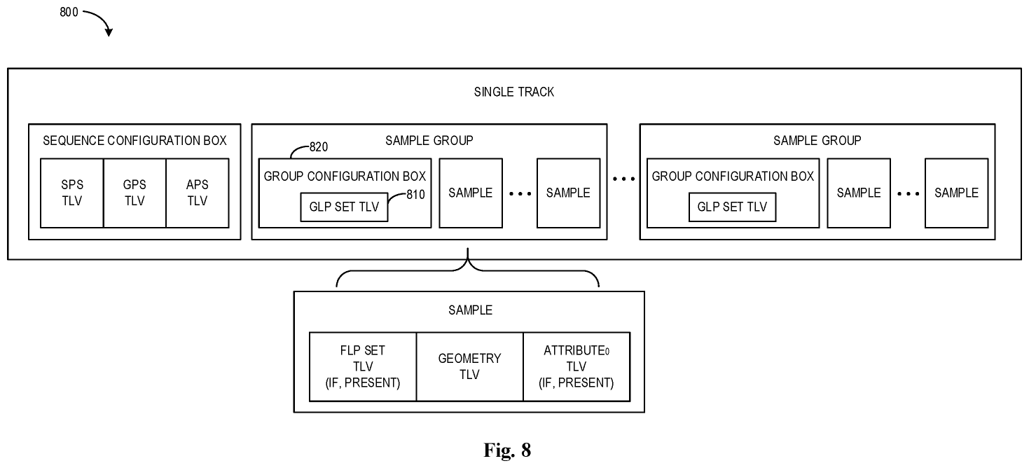

FIG. 8 depicts an example of the G-PCC bitstream which is stored in a single track in this case.

The embodiments of the present disclosure are related to coding and encapsulation of coding parameters in point cloud coding. As used herein, the term “point cloud sequence” may refer to a sequence of one or more point clouds. The term “frame” may refer to a point cloud in a point cloud sequence. The term “sample” may refer to a part of a frame or a entire frame.

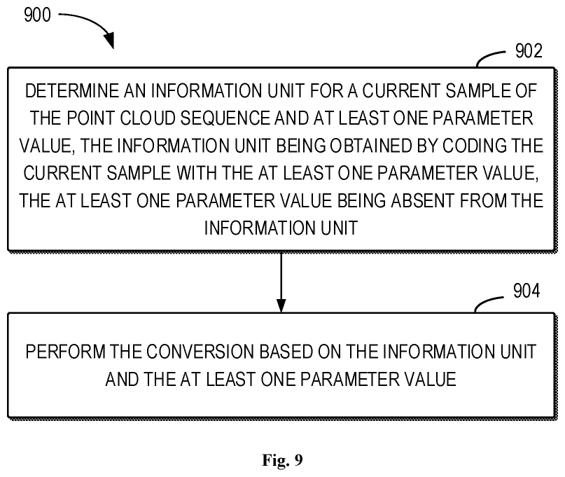

FIG. 9 illustrates a flowchart of a method 900 for point cloud coding in accordance with some embodiments of the present disclosure. The method 900 may be implemented during a conversion between a point cloud sequence and a bitstream of the point cloud sequence. As shown in FIG. 9, the method 900 starts at 902, where an information unit for a current sample of the point cloud sequence and at least one parameter value are determined. The information unit is obtained by coding the current sample with the at least one parameter value and the at least one parameter value is absent from the information unit. By way of example, with reference to FIG. 6, the information unit 610 may be obtained by coding a sample of the point cloud sequence with a plurality of parameter values. The information unit 612 may comprise a geometry type-length-value (TLV) unit 612 containing geometry information of the sample and an attribute TLV unit 614 containing attribute information of the sample. For a sample without attribute information, the attribute TLV unit may be omitted. The plurality of parameter values may be encapsulated into three TLV units, i.e., sequence parameter set (SPS) TLV unit 622, geometry parameter set (GPS) TLV unit 624 and attribute parameter set (APS) TLV unit 626, based on the type of the corresponding parameter. It should be understood that the above illustrations are described merely for purpose of description. The scope of the present disclosure is not limited in this respect.

At 904, the conversion is performed based on the information unit and the at least one parameter value. In some embodiments the conversion may include encoding the point cloud sequence into the bitstream. Alternatively or additionally, the conversion may include decoding the point cloud sequence from the bitstream.

According to the method 900, the at least one parameter value for coding a sample of the point cloud sequence is not included in the corresponding information unit of the sample, which makes it possible to group parameter values together for a plurality of samples so as to avoid redundancy of parameter values to be transmitted. Compared with a conventional solution where parameter values are transmitted for each of samples of the point cloud sequence, the method 900 can advantageously reduce the coding bits while maintaining the coding quality, and the coding efficiency may be improved.

In some embodiments, the at least one parameter value comprises at least one set of values of a group of sequence level parameters, the group of sequence level parameters comprise one or more sequence level parameters for coding all of samples in the point cloud sequence. In some embodiments, the at least one set of values may be encapsulated in a type-length-value (TLV) format.

In some embodiments, the at least one set of values may be indicated in the bitstream before information units for all of samples of the point cloud sequence. Alternatively, the at least one set of values may be indicated in the bitstream after information units for all of samples of the point cloud sequence.

In some embodiments, the at least one set of values may be indicated at a first level structure. For example, the first level structure may be a sequence level structure, such as a SPS TLV unit, a GPV TLV unit, or an APS TLV unit. It should be understood that the above examples are described merely for purpose of description. The scope of the present disclosure is not limited in this respect.

In some embodiments, the at least one set of values comprise all of sets of values of the group of sequence level parameters for coding the point cloud sequence, the number of sets of the all of sets of values may be indicated in the bitstream.

In some embodiments, the at least one set of values may be indicated in the bitstream before a second level structure, a level of the second level structure may be lower than a sequence level. In one example, the second level may be a frame level. Alternatively, the second level may be a picture level. In another example, the second level may be a slice level. In a further example, the second level may be a tile level. In yet another example, the second level may be a subpicture level. It should be understood that the above examples are described merely for purpose of description. The scope of the present disclosure is not limited in this respect.

In some embodiments, at least one indication of the at least one set of values may be indicated in the bitstream at the second level structure. Alternatively, information on whether at least one indication of the at least one set of values is indicated in the bitstream may be determined based on the number of sets of all of sets of values of the group of sequence level parameters for coding the point cloud sequence. For example, the at least one indication in indicated in the bitstream only if the number of sets is larger than one. It should be understood that the above examples are described merely for purpose of description. The scope of the present disclosure is not limited in this respect.

In some embodiments, the at least one indication comprises an index indicating one set of the at least one set of values to be applied on processing the second level structure. By way of example, the index may be referred to as SLP_SPS_id, SLP_GPS_id, or SLP_APS_id. It should be understood that the above illustrations are described merely for purpose of description. The scope of the present disclosure is not limited in this respect.

In some embodiments, the at least one indication may be coded with fixed-length coding. Alternatively, the at least one indication may be coded with unary coding. In some further embodiments, the at least one indication may be coded with truncated unary coding. In some further embodiments, the at least one indication may be coded in a predictive manner.

In some embodiments, the at least one indication may comprise an indication of a single set of values of the group of sequence level parameters for coding the current sample, the indication may be indicated in a geometry data unit header (GSH) or an attribute data unit header (ASH) associated with the current sample.

In some embodiments, the at least one indication may comprise an indication of a single set of values of the group of sequence level parameters for coding the current sample, the indication may be indicated in a configuration box in the information unit of the current sample.

In some embodiments, the at least one set of values may be indicated in one sequence configuration box before information units for all of samples of the point cloud sequence. The sequence configuration box may be a syntax structure containing at least one sequence level syntax element. By way of example, with reference to FIG. 7, the at least one set of values comprise values for sequence parameters, geometry parameters and attribute parameters. The at least one set of values are indicated in the sequence configuration box 710. Thereby, the method according to some embodiments of the present disclosure can advantageously reduce the coding bits while maintaining the coding quality, and the coding efficiency may be improved.

In some embodiments, the sequence configuration box may be indicated at a sequence level structure.

In some embodiments, the at least one set of values may comprise all of sets of values of the group of sequence level parameters for coding the point cloud sequence, the number of sets of the all of sets of values may be indicated in the bitstream.

In some embodiments, the at least one set of values may be indicated before a second level structure, a level of the second level structure may be lower than a sequence level. In one example, the second level may be a frame level. Alternatively, the second level may be a picture level. In another example, the second level may be a slice level. In a further example, the second level may be a tile level. In yet another example, the second level may be a subpicture level. It should be understood that the above examples are described merely for purpose of description. The scope of the present disclosure is not limited in this respect.

In some embodiments, at least one indication of the at least one set of values may be indicated in the bitstream at the second level structure. Alternatively, information on whether at least one indication of the at least one set of values may be indicated in the bitstream may be determined based on the number of sets of all of sets of values of the group of sequence level parameters for coding the point cloud sequence. For example, the at least one indication in indicated in the bitstream only if the number of sets is larger than one. It should be understood that the above examples are described merely for purpose of description. The scope of the present disclosure is not limited in this respect.

In some embodiments, the at least one indication may comprise an index indicating one set of the at least one set of values to be applied on processing the second level structure. By way of example, the index may be referred to as SLP_sequence_parameters_id, SLP_geometry_parameters_id, or SLP_attribute_paramteters_id. It should be understood that the above illustrations are described merely for purpose of description. The scope of the present disclosure is not limited in this respect.

In some embodiments, the at least one indication may be coded with fixed-length coding. Alternatively, the at least one indication may be coded with unary coding. In some further embodiments, the at least one indication may be coded with truncated unary coding. In some further embodiments, the at least one indication may be coded in a predictive manner.

In some embodiments, the at least one indication may comprise an indication of a single set of values of the group of sequence level parameters for coding the current sample, the indication may be indicated in the information unit of the current sample.

In some embodiments, the at least one set of values may comprise a first set of values of the group of sequence level parameters for coding a first sample of the point cloud sequence. The first sample may be coded before all of other samples of the point cloud sequence and the at least one set of values may be indicated in the bitstream. The at least one set of values may further comprise a current set of values of the group of sequence level parameters for coding the current sample, the current set of values may be different from a second set of values of the group of sequence level parameters for coding a coded sample immediately preceding the current sample. Thereby, the method according to some embodiments of the present disclosure can advantageously reduce the coding bits while maintaining the coding quality, and the coding efficiency may be improved.

In some embodiments, the coded sample and the current sample may be in the same frame. Alternatively, the coded sample and the current sample may be in different frames. In some embodiments, the number of sets of the at least one set of values may be larger than one.

In some embodiments, an indication may be indicated in the bitstream at a second level structure. A level of the second level structure may be lower than a sequence level. The indication may indicate whether the current set of values may be different from the second set of values.

In some embodiments, information on whether the current set of values are different from the second set of values may be determined implicitly. For example, the information may be determined based on a coding process of the point cloud sequence or a comparison between the current set of values and the second set of values. It should be understood that the above illustrations and/or examples are described merely for purpose of description. The scope of the present disclosure is not limited in this respect.

In some embodiments, information on whether an indication may be indicated in the bitstream may be determined based on the number of sets of all of sets of values of the group of sequence level parameters for coding the point cloud sequence. The indication may indicate whether the current set of values are different from the second set of values.

In some embodiments, the indication may comprise an index indicating whether the current set of values may be different from the second set of values.

In some embodiments, the indication may be coded with fixed-length coding. Alternatively, the indication may be coded with unary coding. In some further embodiments, the indication may be coded with truncated unary coding. In some further embodiments, the indication may be coded in a predictive manner. In some embodiments, the indication may be indicated in the information unit of the current sample.

In some embodiments, the current set of values may be indicated in the information unit of the current sample, if the current set of values are different from the second set of values. In some embodiments, the second set of values may be applied on coding the current sample, if the current set of values are the same as the second set of values.

In some embodiments, the at least one set of values may comprise a first set of values of the group of sequence level parameters for coding a first sample of the point cloud sequence. The first sample may be coded before all of other samples of the point cloud sequence, and the at least one set of values may be indicated in the bitstream. The at least one set of values may further comprise a current set of values of the group of sequence level parameters for coding the current sample. The current set of values may be different from all of previous sets of values of the group of sequence level parameters for coding coded samples preceding the current sample. Thereby, the method according to some embodiments of the present disclosure can advantageously reduce the coding bits while maintaining the coding quality, and the coding efficiency may be improved.

In some embodiments, the coded sample and the current sample may be in the same frame. Alternatively, the coded sample and the current sample may be in different frames. In some embodiments, the number of sets of the at least one set of values may be larger than one.

In some embodiments, a first indication may be indicated in the bitstream at a second level structure. A level of the second level structure may be lower than a sequence level. The first indication may indicate whether the current set of values may be different from all of the previous sets of values.

In some embodiments, information on whether the current set of values are different from all of the previous sets of values may be determined implicitly. For example, the information may be determined based on a coding process of the point cloud sequence or a comparison between the current set of values and each of the previous sets of values. It should be understood that the above illustrations and/or examples are described merely for purpose of description. The scope of the present disclosure is not limited in this respect.

In some embodiments, information on whether a first indication may be indicated in the bitstream may be determined based on the number of sets of all of sets of values of the group of sequence level parameters for coding the point cloud sequence. The first indication may indicate whether the current set of values are different from all of the previous sets of values.

In some embodiments, the first indication may comprise an index indicating whether the current set of values may be different from all of the previous sets of values.

In some embodiments, the first indication may be coded with fixed-length coding. Alternatively, the first indication may be coded with unary coding. In some further embodiments, the first indication may be coded with truncated unary coding. In some further embodiments, the first indication may be coded in a predictive manner. In some embodiments, the first indication may be indicated in the information unit of the current sample.

In some embodiments, the current set of values may be indicated in the information unit of the current sample, if the current set of values may be different from all of the previous sets of values. In some further embodiments, if the current set of values may be the same as a second set of values of the previous sets of values, the second set of values may be applied on coding the current sample.

In some embodiments, a second indication of a second set of values applied on coding the current sample may be indicated in the bitstream. In some embodiments, information on whether a second indication of a second set of values applied on coding the current sample is indicated in the bitstream may be determined based on whether the second set of values are determined from the previous sets of values.

In some embodiments, the second indication may be coded with fixed-length coding. Alternatively, the second indication may be coded with unary coding. In some further embodiments, the second indication may be coded with truncated unary coding. In some further embodiments, the second indication may be coded in a predictive manner. In some embodiments, the second indication may be indicated in the information unit of the current sample.

In some embodiments, the at least one parameter value may comprise at least one set of values of a set of group of frame (GOF) level parameters. The set of GOF level parameters may comprise one or more GOF level parameters for coding all of samples of a GOF in the point cloud sequence. Thereby, the method according to some embodiments of the present disclosure can advantageously reduce the coding bits while maintaining the coding quality, and the coding efficiency may be improved.

In some embodiments, the at least one set of values may be encapsulated in a type-length-value (TLV) format and indicated in the bitstream before information units for samples of the GOF. By way of example, with reference to FIG. 8, the at least one set of values may be encapsulated in the GLP set TLV unit 810, and the GLP set TLV unit 810 may be indicated in a group configuration box 820 before information units for samples of the GOF.

In some embodiments, the at least one set of values may be indicated in the bitstream at GOF level. In some embodiments, each set of the at least one set of values may be indicated in one TLV for one GOF. In some embodiments, the at least one set of values may be indicated in the bitstream before information units for samples in the GOF. In some embodiments, the at least one set of values may be applied to all of samples in the GOF.

In some embodiments, a bitstream of a point cloud sequence may be stored in a non-transitory computer-readable recording medium. The bitstream of the point cloud sequence can be generated by a method performed by a point cloud processing apparatus. According to the method, an information unit for a current sample of the point cloud sequence and at least one parameter value are determined. The information unit is obtained by coding the current sample with the at least one parameter value and the at least one parameter value is absent from the information unit. A bitstream of the current frame may be generated based on the information unit and the at least one parameter value.

In some embodiments, an information unit for a current sample of the point cloud sequence and at least one parameter value are determined. The information unit is obtained by coding the current sample with the at least one parameter value and the at least one parameter value is absent from the information unit. A bitstream of the current frame may be generated based on the information unit and the at least one parameter value. The bitstream may be stored in a non-transitory computer-readable recording medium.

Implementations of the present disclosure can be described in view of the following clauses, the features of which can be combined in any reasonable manner.

Clause 1. A method for point cloud coding, comprising: determining, during a conversion between a point cloud sequence and a bitstream of the point cloud sequence, an information unit for a current sample of the point cloud sequence and at least one parameter value, the information unit being obtained by coding the current sample with the at least one parameter value, the at least one parameter value being absent from the information unit; and performing the conversion based on the information unit and the at least one parameter value.

Clause 2. The method of clause 1, wherein the at least one parameter value comprises at least one set of values of a group of sequence level parameters, the group of sequence level parameters comprise one or more sequence level parameters for coding all of samples in the point cloud sequence.

Clause 3. The method of clause 2, wherein the at least one set of values are encapsulated in a type-length-value (TLV) format.

Clause 4. The method of any of clauses 2-3, wherein the at least one set of values are indicated in the bitstream before information units for all of samples of the point cloud sequence, or the at least one set of values are indicated in the bitstream after information units for all of samples of the point cloud sequence.

Clause 5. The method of any of clauses 2-4, wherein the at least one set of values are indicated at a first level structure.

Clause 6. The method of clause 5, wherein the first level structure is a sequence level structure.

Clause 7. The method of any of clauses 2-6, wherein the at least one set of values comprise all of sets of values of the group of sequence level parameters for coding the point cloud sequence, the number of sets of the all of sets of values is indicated in the bitstream.

Clause 8. The method of any of clauses 2-7, wherein the at least one set of values are indicated in the bitstream before a second level structure, a level of the second level structure being lower than a sequence level.

Clause 9. The method of clause 8, wherein at least one indication of the at least one set of values is indicated in the bitstream at the second level structure.

Clause 10. The method of clause 8, wherein information on whether at least one indication of the at least one set of values is indicated in the bitstream is determined based on the number of sets of all of sets of values of the group of sequence level parameters for coding the point cloud sequence.

Clause 11. The method of any of clauses 9-10, wherein the at least one indication comprises an index indicating one set of the at least one set of values to be applied on processing the second level structure.

Clause 12. The method of any of clauses 9-11, wherein the at least one indication is coded with one of: fixed-length coding, unary coding, or truncated unary coding.

Clause 13. The method of any of clauses 9-11, wherein the at least one indication is coded in a predictive manner.

Clause 14. The method of any of clauses 9-11, wherein the at least one indication comprises an indication of a single set of values of the group of sequence level parameters for coding the current sample, the indication is indicated in a geometry data unit header (GSH) or an attribute data unit header (ASH) associated with the current sample.

Clause 15. The method of any of clauses 9-11, wherein the at least one indication comprises an indication of a single set of values of the group of sequence level parameters for coding the current sample, the indication is indicated in a configuration box in the information unit of the current sample.

Clause 16. The method of any of clauses 2-3, wherein the at least one set of values are indicated in one sequence configuration box before information units for all of samples of the point cloud sequence, the sequence configuration box being a syntax structure containing at least one sequence level syntax element.

Clause 17. The method of clause 16, wherein the sequence configuration box is indicated at a sequence level structure.

Clause 18. The method of any of clauses 16-17, wherein the at least one set of values comprise all of sets of values of the group of sequence level parameters for coding the point cloud sequence, the number of sets of the all of sets of values is indicated in the bitstream.

Clause 19. The method of any of clauses 16-18, wherein the at least one set of values are indicated before a second level structure, a level of the second level structure being lower than a sequence level.

Clause 20. The method of clause 19, wherein at least one indication of the at least one set of values is indicated in the bitstream at the second level structure.

Clause 21. The method of clause 19, wherein information on whether at least one indication of the at least one set of values is indicated in the bitstream is determined based on the number of sets of all of sets of values of the group of sequence level parameters for coding the point cloud sequence.

Clause 22. The method of any of clauses 20-21, wherein the at least one indication comprises an index indicating one set of the at least one set of values to be applied on processing the second level structure.

Clause 23. The method of any of clauses 20-22, wherein the at least one indication is coded with one of: fixed-length coding, unary coding, or truncated unary coding.

Clause 24. The method of any of clauses 20-22, wherein the at least one indication is coded in a predictive manner.

Clause 25. The method of any of clauses 20-22, wherein the at least one indication comprises an indication of a single set of values of the group of sequence level parameters for coding the current sample, the indication is indicated in the information unit of the current sample.

Clause 26. The method of any of clauses 2-3, wherein the at least one set of values comprise a first set of values of the group of sequence level parameters for coding a first sample of the point cloud sequence, the first sample is coded before all of other samples of the point cloud sequence, the at least one set of values are indicated in the bitstream, and wherein the at least one set of values further comprise a current set of values of the group of sequence level parameters for coding the current sample, the current set of values are different from a second set of values of the group of sequence level parameters for coding a coded sample immediately preceding the current sample.

Clause 27. The method of clause 26, wherein the number of sets of the at least one set of values is larger than one.

Clause 28. The method of any of clauses 26-27, wherein an indication is indicated in the bitstream at a second level structure, a level of the second level structure being lower than a sequence level, the indication indicating whether the current set of values are different from the second set of values.

Clause 29. The method of clause 28, wherein information on whether the current set of values are different from the second set of values is determined based on a coding process of the point cloud sequence or a comparison between the current set of values and the second set of values.

Clause 30. The method of any of clauses 26-27, wherein information on whether an indication is indicated in the bitstream is determined based on the number of sets of all of sets of values of the group of sequence level parameters for coding the point cloud sequence, the indication indicating whether the current set of values are different from the second set of values.

Clause 31. The method of any of clauses 28-30, wherein the indication comprises an index indicating whether the current set of values are different from the second set of values.

Clause 32. The method of any of clauses 28-31, wherein the indication is coded with one of: fixed-length coding, unary coding, or truncated unary coding.

Clause 33. The method of any of clauses 28-31, wherein the indication is coded in a predictive manner.

Clause 34. The method of any of clauses 28-31, wherein the indication is indicated in the information unit of the current sample.

Clause 35. The method of any of clauses 28-34, wherein the current set of values are indicated in the information unit of the current sample, if the current set of values are different from the second set of values.

Clause 36. The method of any of clauses 28-34, wherein the second set of values is applied on coding the current sample, if the current set of values are the same as the second set of values.

Clause 37. The method of any of clauses 2-3, wherein the at least one set of values comprise a first set of values of the group of sequence level parameters for coding a first sample of the point cloud sequence, the first sample is coded before all of other samples of the point cloud sequence, the at least one set of values are indicated in the bitstream, and wherein the at least one set of values further comprise a current set of values of the group of sequence level parameters for coding the current sample, the current set of values are different from all of previous sets of values of the group of sequence level parameters for coding coded samples preceding the current sample.

Clause 38. The method of clause 37, wherein the number of sets of the at least one set of values is larger than one.

Clause 39. The method of any of clauses 37-38, wherein a first indication is indicated in the bitstream at a second level structure, a level of the second level structure being lower than a sequence level, the first indication indicating whether the current set of values are different from all of the previous sets of values.

Clause 40. The method of clause 39, wherein information on whether the current set of values are different from all of the previous sets of values is determined based on a coding process of the point cloud sequence or a comparison between the current set of values and each of the previous sets of values.

Clause 41. The method of any of clauses 37-38, wherein information on whether a first indication is indicated in the bitstream is determined based on the number of sets of all of sets of values of the group of sequence level parameters for coding the point cloud sequence, the first indication indicating whether the current set of values are different from all of the previous sets of values.

Clause 42. The method of any of clauses 39-41, wherein the first indication comprises an index indicating whether the current set of values are different from all of the previous sets of values.

Clause 43. The method of any of clauses 39-42, wherein the first indication is coded with one of: fixed-length coding, unary coding, or truncated unary coding.

Clause 44. The method of any of clauses 39-42, wherein the first indication is coded in a predictive manner.

Clause 45. The method of any of clauses 39-42, wherein the first indication is indicated in the information unit of the current sample.

Clause 46. The method of any of clauses 39-45, wherein the current set of values are indicated in the information unit of the current sample, if the current set of values are different from all of the previous sets of values.

Clause 47. The method of any of clauses 39-45, wherein if the current set of values are the same as a second set of values of the previous sets of values, the second set of values is applied on coding the current sample.

Clause 48. The method of any of clauses 39-45, wherein a second indication of a second set of values applied on coding the current sample is indicated in the bitstream.

Clause 49. The method of any of clauses 39-45, wherein information on whether a second indication of a second set of values applied on coding the current sample is indicated in the bitstream is determined based on whether the second set of values is determined from the previous sets of values.

Clause 50. The method of any of clauses 48-49, wherein the second indication is coded with one of: fixed-length coding, unary coding, or truncated unary coding.

Clause 51. The method of any of clauses 48-49, wherein the second indication is coded in a predictive manner.

Clause 52. The method of any of clauses 48-49, wherein the second indication is indicated in the information unit of the current sample.

Clause 53. The method of clause 1, wherein the at least one parameter value comprises at least one set of values of a set of group of frame (GOF) level parameters, the set of GOF level parameters comprise one or more GOF level parameters for coding all of samples of a GOF in the point cloud sequence.

Clause 54. The method of clause 53, wherein the at least one set of values are encapsulated in a type-length-value (TLV) format and indicated in the bitstream before information units for samples of the GOF.

Clause 55. The method of any of clauses 53-54, wherein the at least one set of values are indicated in the bitstream at GOF level.

Clause 56. The method of clause 55, wherein each set of the at least one set of values is indicated in one TLV for one GOF.

Clause 57. The method of clause 53, wherein the at least one set of values are indicated in the bitstream before information units for samples in the GOF.

Clause 58. The method of any of clauses 53-57, wherein the at least one set of values are applied to all of samples in the GOF.

Clause 59. The method of any of clauses 1-58, wherein the conversion includes encoding the point cloud sequence into the bitstream.

Clause 60. The method of any of clauses 1-58, wherein the conversion includes decoding the point cloud sequence from the bitstream.

Clause 61. An apparatus for processing point cloud data comprising a processor and a non-transitory memory with instructions thereon, wherein the instructions upon execution by the processor, cause the processor to perform a method in accordance with any of Clauses 1-60.

Clause 62. A non-transitory computer-readable storage medium storing instructions that cause a processor to perform a method in accordance with any of Clauses 1-60.

Clause 63. A non-transitory computer-readable recording medium storing a bitstream of a point cloud sequence which is generated by a method performed by a point cloud processing apparatus, wherein the method comprises: determining an information unit for a current sample of the point cloud sequence and at least one parameter value, the information unit being obtained by coding the current sample with the at least one parameter value, the at least one parameter value being absent from the information unit; and generating the bitstream based on the information unit and the at least one parameter value.

Clause 64. A method for storing a bitstream of a point cloud sequence, comprising: determining an information unit for a current sample of the point cloud sequence and at least one parameter value, the information unit being obtained by coding the current sample with the at least one parameter value, the at least one parameter value being absent from the information unit; generating the bitstream based on the information unit and the at least one parameter value; and storing the bitstream in a non-transitory computer-readable recording medium.

### Example Device

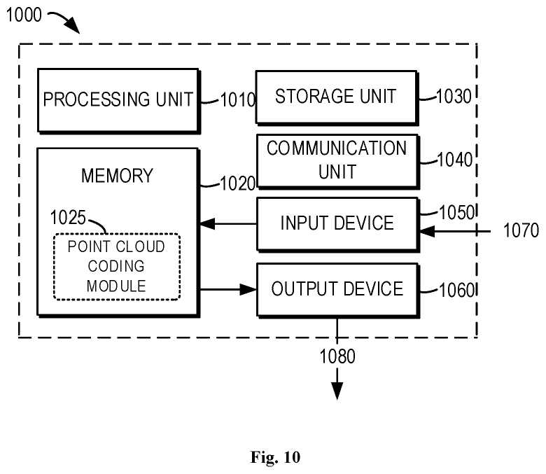

FIG. 10 illustrates a block diagram of a computing device 1000 in which various embodiments of the present disclosure can be implemented. The computing device 1000 may be implemented as or included in the source device 110 (or the GPCC encoder 116 or 200) or the destination device 120 (or the GPCC decoder 126 or 300).

It would be appreciated that the computing device 1000 shown in FIG. 10 is merely for purpose of illustration, without suggesting any limitation to the functions and scopes of the embodiments of the present disclosure in any manner.

As shown in FIG. 10, the computing device 1000 includes a general-purpose computing device 1000. The computing device 1000 may at least comprise one or more processors or processing units 1010, a memory 1020, a storage unit 1030, one or more communication units 1040, one or more input devices 1050, and one or more output devices 1060.

In some embodiments, the computing device 1000 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1000 can support any type of interface to a user (such as “wearable” circuitry and the like).

The processing unit 1010 may be a physical or virtual processor and can implement various processes based on programs stored in the memory 1020. In a multi-processor system, multiple processing units execute computer executable instructions in parallel so as to improve the parallel processing capability of the computing device 1000. The processing unit 1010 may also be referred to as a central processing unit (CPU), a microprocessor, a controller or a microcontroller.

The computing device 1000 typically includes various computer storage medium. Such medium can be any medium accessible by the computing device 1000, including, but not limited to, volatile and non-volatile medium, or detachable and non-detachable medium. The memory 1020 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1030 may be any detachable or non-detachable medium and may include a machine-readable medium such as a memory, flash memory drive, magnetic disk or another other media, which can be used for storing information and/or data and can be accessed in the computing device 1000.

The computing device 1000 may further include additional detachable/non-detachable, volatile/non-volatile memory medium. Although not shown in FIG. 10, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1040 communicates with a further computing device via the communication medium. In addition, the functions of the components in the computing device 1000 can be implemented by a single computing cluster or multiple computing machines that can communicate via communication connections. Therefore, the computing device 1000 can operate in a networked environment using a logical connection with one or more other servers, networked personal computers (PCs) or further general network nodes.

The input device 1050 may be one or more of a variety of input devices, such as a mouse, keyboard, tracking ball, voice-input device, and the like. The output device 1060 may be one or more of a variety of output devices, such as a display, loudspeaker, printer, and the like. By means of the communication unit 1040, the computing device 1000 can further communicate with one or more external devices (not shown) such as the storage devices and display device, with one or more devices enabling the user to interact with the computing device 1000, or any devices (such as a network card, a modem and the like) enabling the computing device 1000 to communicate with one or more other computing devices, if required. Such communication can be performed via input/output (I/O) interfaces (not shown).

In some embodiments, instead of being integrated in a single device, some or all components of the computing device 1000 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1000 may be used to implement point cloud encoding/decoding in embodiments of the present disclosure. The memory 1020 may include one or more point cloud coding modules 1025 having one or more program instructions. These modules are accessible and executable by the processing unit 1010 to perform the functionalities of the various embodiments described herein.

In the example embodiments of performing point cloud encoding, the input device 1050 may receive point cloud data as an input 1070 to be encoded. The point cloud data may be processed, for example, by the point cloud coding module 1025, to generate an encoded bitstream. The encoded bitstream may be provided via the output device 1060 as an output 1080.

In the example embodiments of performing point cloud decoding, the input device 1050 may receive an encoded bitstream as the input 1070. The encoded bitstream may be processed, for example, by the point cloud coding module 1025, to generate decoded point cloud data. The decoded point cloud data may be provided via the output device 1060 as the output 1080.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for point cloud coding, comprising:
determining, during a conversion between a point cloud sequence and a bitstream of the point cloud sequence, an information unit for a current sample of the point cloud sequence and at least one parameter value, the information unit being obtained by coding the current sample with the at least one parameter value, the at least one parameter value being absent from the information unit; and
performing the conversion based on the information unit and the at least one parameter value.

2. The method of claim 1, wherein the at least one parameter value comprises at least one set of values of a group of sequence level parameters, the group of sequence level parameters comprise one or more sequence level parameters for coding all of samples in the point cloud sequence.

3. The method of claim 2, wherein the at least one set of values are encapsulated in a type-length-value (TLV) format, or
wherein the at least one set of values are indicated in the bitstream before information units for all of samples of the point cloud sequence, or
the at least one set of values are indicated in the bitstream after information units for all of samples of the point cloud sequence, or
wherein the at least one set of values are indicated at a first level structure, or
wherein the at least one set of values comprise all of sets of values of the group of sequence level parameters for coding the point cloud sequence, the number of sets of the all of sets of values is indicated in the bitstream, or
wherein the at least one set of values are indicated in the bitstream before a second level structure, a level of the second level structure being lower than a sequence level.

4. The method of claim 3, wherein at least one indication of the at least one set of values is indicated in the bitstream at the second level structure, or
wherein information on whether at least one indication of the at least one set of values is indicated in the bitstream is determined based on the number of sets of all of sets of values of the group of sequence level parameters for coding the point cloud sequence.

5. The method of claim 4, wherein the at least one indication comprises an index indicating one set of the at least one set of values to be applied on processing the second level structure, or
wherein the at least one indication is coded with one of: fixed-length coding, unary coding, or truncated unary coding, or
wherein the at least one indication is coded in a predictive manner, or
wherein the at least one indication comprises an indication of a single set of values of the group of sequence level parameters for coding the current sample, the indication is indicated in a geometry data unit header (GSH) or an attribute data unit header (ASH) associated with the current sample, or
wherein the at least one indication comprises an indication of a single set of values of the group of sequence level parameters for coding the current sample, the indication is indicated in a configuration box in the information unit of the current sample.

6. The method of claim 2, wherein the at least one set of values are indicated in one sequence configuration box before information units for all of samples of the point cloud sequence, the sequence configuration box being a syntax structure containing at least one sequence level syntax element.

7. The method of claim 6, wherein the sequence configuration box is indicated at a sequence level structure, or
wherein the at least one set of values comprise all of sets of values of the group of sequence level parameters for coding the point cloud sequence, the number of sets of the all of sets of values is indicated in the bitstream.

8. The method of claim 6, wherein the at least one set of values are indicated before a second level structure, a level of the second level structure being lower than a sequence level.

9. The method of claim 8, wherein at least one indication of the at least one set of values is indicated in the bitstream at the second level structure, or
wherein information on whether at least one indication of the at least one set of values is indicated in the bitstream is determined based on the number of sets of all of sets of values of the group of sequence level parameters for coding the point cloud sequence.

10. The method of claim 9, wherein the at least one indication comprises an index indicating one set of the at least one set of values to be applied on processing the second level structure, or
wherein the at least one indication is coded with one of: fixed-length coding, unary coding, or truncated unary coding, or
wherein the at least one indication is coded in a predictive manner, or
wherein the at least one indication comprises an indication of a single set of values of the group of sequence level parameters for coding the current sample, the indication is indicated in the information unit of the current sample.

11. The method of claim 2, wherein the at least one set of values comprise a first set of values of the group of sequence level parameters for coding a first sample of the point cloud sequence, the first sample is coded before all of other samples of the point cloud sequence, the at least one set of values are indicated in the bitstream, and wherein the at least one set of values further comprise a current set of values of the group of sequence level parameters for coding the current sample, the current set of values are different from a second set of values of the group of sequence level parameters for coding a coded sample immediately preceding the current sample, or
wherein the at least one set of values comprise a first set of values of the group of sequence level parameters for coding a first sample of the point cloud sequence, the first sample is coded before all of other samples of the point cloud sequence, the at least one set of values are indicated in the bitstream, and wherein the at least one set of values further comprise a current set of values of the group of sequence level parameters for coding the current sample, the current set of values are different from all of previous sets of values of the group of sequence level parameters for coding coded samples preceding the current sample.

12. The method of claim 11, wherein the number of sets of the at least one set of values is larger than one, or
wherein an indication is indicated in the bitstream at a second level structure, a level of the second level structure being lower than a sequence level, the indication indicating whether the current set of values are different from the second set of values, or
wherein information on whether an indication is indicated in the bitstream is determined based on the number of sets of all of sets of values of the group of sequence level parameters for coding the point cloud sequence, the indication indicating whether the current set of values are different from the second set of values, or
wherein a first indication is indicated in the bitstream at a second level structure, a level of the second level structure being lower than a sequence level, the first indication indicating whether the current set of values are different from all of the previous sets of values, or
wherein information on whether a first indication is indicated in the bitstream is determined based on the number of sets of all of sets of values of the group of sequence level parameters for coding the point cloud sequence, the first indication indicating whether the current set of values are different from all of the previous sets of values.

13. The method of claim 1, wherein the at least one parameter value comprises at least one set of values of a set of group of frame (GOF) level parameters, the set of GOF level parameters comprise one or more GOF level parameters for coding all of samples of a GOF in the point cloud sequence.

14. The method of claim 13, wherein the at least one set of values are encapsulated in a type-length-value (TLV) format and indicated in the bitstream before information units for samples of the GOF, or
wherein the at least one set of values are indicated in the bitstream before information units for samples in the GOF, or
wherein the at least one set of values are applied to all of samples in the GOF.

15. The method of claim 13, wherein the at least one set of values are indicated in the bitstream at GOF level.

16. The method of claim 15, wherein each set of the at least one set of values is indicated in one TLV for one GOF.

17. The method of claim 1, wherein the conversion includes encoding the point cloud sequence into the bitstream, or
wherein the conversion includes decoding the point cloud sequence from the bitstream.

18. An apparatus for processing point cloud data comprising a processor and a non-transitory memory with instructions thereon, wherein the instructions upon execution by the processor, cause the processor to:
determine, during a conversion between a point cloud sequence and a bitstream of the point cloud sequence, an information unit for a current sample of the point cloud sequence and at least one parameter value, the information unit being obtained by coding the current sample with the at least one parameter value, the at least one parameter value being absent from the information unit; and
perform the conversion based on the information unit and the at least one parameter value.

19. A non-transitory computer-readable storage medium storing instructions that cause a processor to:
determine, during a conversion between a point cloud sequence and a bitstream of the point cloud sequence, an information unit for a current sample of the point cloud sequence and at least one parameter value, the information unit being obtained by coding the current sample with the at least one parameter value, the at least one parameter value being absent from the information unit; and
perform the conversion based on the information unit and the at least one parameter value.

20. A non-transitory computer-readable recording medium storing a bitstream of a point cloud sequence which is generated by a method performed by a point cloud processing apparatus, wherein the method comprises:
determining an information unit for a current sample of the point cloud sequence and at least one parameter value, the information unit being obtained by coding the current sample with the at least one parameter value, the at least one parameter value being absent from the information unit; and
generating the bitstream based on the information unit and the at least one parameter value.
